(19) United States
(12) Patent Application Publication
(10) Pub. No.: US 2016/0027035 A1
(43) Pub. Date: Jan. 28, 2016

(54) OPTIMIZING RETRIEVAL OF USER INTERACTIONS FOR DETERMINING CONTRIBUTIONS TO A CONVERSION

(71) Applicant: Facebook, Inc., Menlo Park, CA (US)

(72) Inventors: Sergio Silveria Clemente Filho, Kirkland, WA (US); Jason George McHugh, Seattle, WA (US)

(21) Appl. No.: 14/340,587

(22) Filed: Jul. 25, 2014

(51) Int. Cl. G06Q 30/02; H04L 29/08

(52) U.S. Cl. CPC G06Q 30/0242; H04L 67/02

(57) ABSTRACT

An online system maintains information describing user interactions with advertisements and other content. Additionally, the online system maintains various types of information identifying users and confidence values associated with each type of information identifying users that provide a measure of the likelihood of a type of information identifying a specific user. Example types of information identifying a user include an online system identifier, a client device identifier, and an application identifier. When the online system receives information indicating a user has performed a conversion, the online system retrieves interactions associated with at least one type of information identifying the user. An attribution model is applied to the retrieved interactions to determine contributions of various interactions to the conversion, accounting for the confidence values associated with types of information identifying the user associated with various interactions.

### BACKGROUND

This disclosure relates generally to monitoring conversions, and in particular to determining contributions of interactions to a performed conversion.

A content provider may associate a conversion with content provided by a content provider to an online system for presentation. The conversion identifies an interaction or a type of interaction the content provider desires users of the online system to perform when presented with the content. For example, the content provider associates a conversion with content for a user to access a website associated with content presented by the online system or to install an application identified by content presented by the online system.

However, users often perform multiple interactions captured by the online system before performing a conversion associated with content presented by the online system. Various interactions performed by the user may increase or decrease the likelihood of the user performing a conversion. However, information describing different interactions performed by a user communicated to the online system may include different types of information identifying the user. This use of different types of user identifying information prevents conventional online systems from accurately identifying prior interactions by a user that may have contributed to a conversion performed by the user.

### SUMMARY

To provide advertisers with more accurate information about the contribution of various interactions by a user to a conversion associated with the user, an online system identifies interactions by the user prior to the conversion and determines a contribution of different interactions to the conversion. The contribution of an interaction to the conversion provides a measure of the interaction's influence on the user performing the conversion. The online system stores information describing various interactions performed by a user as well as information associated with conversions identified to the online system. Examples of information associated with an interaction by the online system include: a description of a type of the interaction (e.g., impression of an advertisement, interaction with an advertisement or link, search performed online, online purchase, etc.), information identifying a user performing the interaction (e.g., an online system user identifier, a device identifier, etc.), and a time associated with the interaction (e.g., a timestamp). Additionally, the online system associates a confidence value with various types of information identifying a user indicating a measure of an ability of a type of information to accurately identify a user. For example, the online system associates a higher confidence value with an online system user identifier than a confidence value associated with a device identifier as multiple users may share a device. In some embodiments, the online system ranks types of information identifying a user based on their associated confidence values, with higher positions in the ranking indicating a higher ability of a type of information to accurately identify a user. When the online system receives information describing a conversion, the online system identifies information identifying the user from the received information and identifies interactions associated with the information identifying the user as well as associated with other types of information identifying the user.

An attribution model is applied to the retrieved interactions to evaluate the contribution of the sources to the conversion. In some embodiments, the attribution model applies weights to different interactions to identify the contributions of various interactions to the conversion. In various embodiments, the weights are based at least in part on the confidence values associated with types of information identifying the user. Additionally, the attribution model may be applied to a subset of the retrieved interactions, such as retrieved interactions associated a type of information identifying the user having at least a threshold confidence value.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of a method for attributing a conversion among one or more interactions, in accordance with an embodiment.

FIG. 4 is an example of information associating interactions and a conversion with types of information identifying an acting user, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

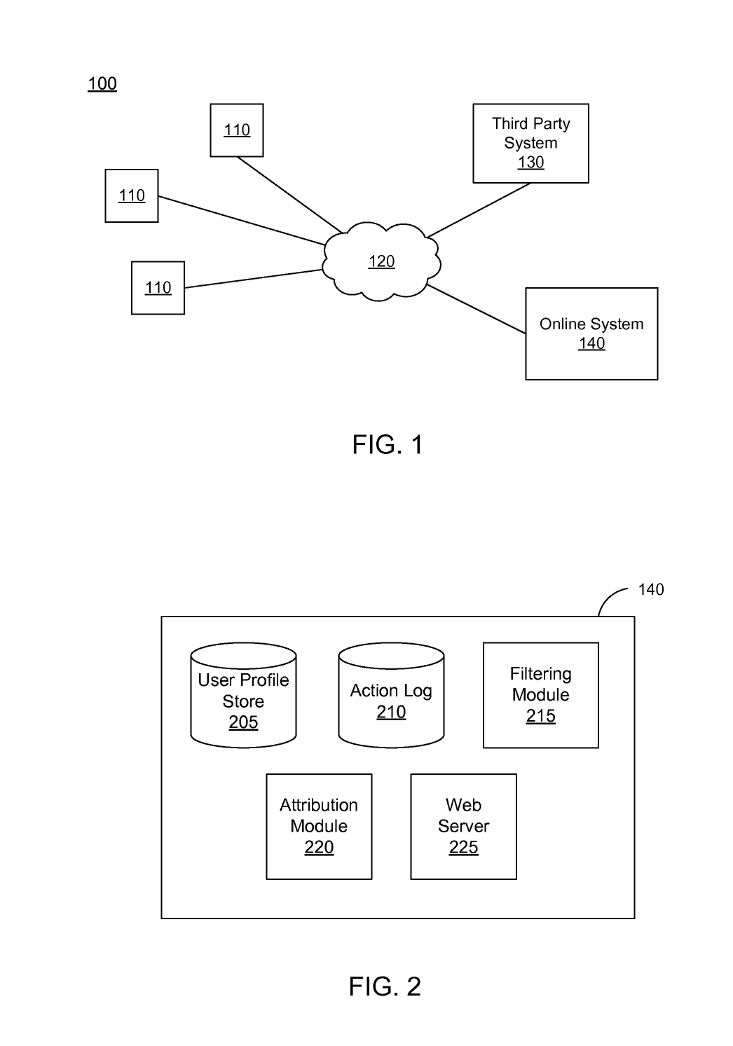

FIG. 1 is a block diagram of a system environment 100 for an online system 140. The system environment 100 shown by FIG. 1 comprises one or more client devices 110, a network 120, one or more third party systems 130, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™. A client device 110 may be associated with one or more users. In some embodiments, a user may access multiple applications, third party systems 130, or some combination thereof, via a client device 110 associated with the user.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. The online system 140 shown in FIG. 2 includes an action log 210a filtering module 215, an attribution module 220, and a web server 225. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system system user. Examples of information stored in a user profile include biographic, demographic, and other types of descriptive information, such as work experience, educational history, gender, hobbies or preferences, location and the like. A user profile in the user profile store 205 may also maintain references to actions stored in the action log 210.

In various embodiments, multiple physical locations associated with a user are included in the user's user profile. A location type is associated with each physical location and describes one or more characteristics of the physical location. For example, a location type specifies a source from which the physical location was determined. In one embodiment, a location type associated with a physical location is selected from a set of location types. For example, a location type identifies a static physical location specified by a user (e.g., a hometown, a residence) or inferred from information associated with the user, another location type identifies a physical location identified in content provided to the online system 140 by the user (e.g., a location identified by a post to the online system 140 by the user, a location to which a user checks-in via a client device 110), and an additional location type identifies a physical location identified by information communicated to the online system 140 by a client device 110 associated with the user (e.g., Global Positioning System coordinates communicated to the online system 140 by a client device 110 executing an application associated with the online system 140). However, in other embodiments, a location type associated with a physical location may identify any suitable characteristic, of combination of characteristics, of the physical location. Additionally, in some embodiments, the location type identifies a current physical location of the user. For example, the online system 140 determines if a physical location associated with the user is the user's current physical location of the user by comparing a time stamp associated with information received from the client device 110 (e.g., via the information communicated to the online system 140 by the client device 110 associated with the user and/or the content provided to the online system 140 by the user discussed above) with a current time. If a difference in the compared times is less than a threshold value, the online system 140 identifies the physical location associated with the user is the current location of the user.

Associating different location types with different physical locations allows a user profile to provide an indication of how likely a user is to be currently associated with the different physical locations. For example, a physical location associated with a location type indicating the physical location was identified by information received by the online system 140 from a client device 110 has a relatively higher likelihood of being associated with a user at a current time than a physical location associated with a location type indicating physical location is a user-specified static physical location. The online system 140 may determine a location type associated with a physical location based on additional information received in conjunction with the physical location. In some embodiments, metadata specifying a location type is received by the online system 140 in conjunction with a physical location.

The action log 210 may store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 210 may record information about actions users perform on a third party system 130, including webpage viewing histories, advertisements that were engaged, purchases made, subscribing to third party services (e.g., movie subscription, music subscription, ebook subscription, etc.) and other patterns from shopping and buying.

The action log 210 includes information describing interactions with content by online system users as well as conversions associated with online system users. A conversion is an action performed by a user that is desired by an advertiser and may be attributed to one or more interactions of the user that are specified by an advertiser to be monitored or tracked. In one embodiment, the action log 210 includes various databases storing information associated with interactions and conversions. For example, the action log 210 includes a write-optimized database storing information associated with multiple interactions and conversions associated with an advertiser. As an additional example, the action log 210 includes a read-optimized database storing information associated with multiple interactions associated with user identifying information matching user identifying information associated with a conversion. Alternatively, the action log 210 includes a single database optimized for a most frequently type of interaction; for example, the action log 210 includes a write optimized database in an implementation where writing to the database is the most common action. Including different types of databases allows the action log 210 to optimize retrieval times for certain types of information and to optimize storage of other types of information.

Example types of information associated with an interaction or a conversion stored in the action log 210 include: a description of a type of interaction (e.g., an impression of an advertisement, access of an advertisement or a link, a search performed by a user, a prior conversion associated with the user) and a time associated with the interaction or the conversion (e.g., a timestamp). Additionally, the action log associates user identifying information with each interaction or conversion to identify the user that performed the interaction or the conversion. Multiple types of information identifying a user may be associated with an interaction or a conversion. Example types of user identifying information include an online system user identifier, a client device identifier, an application identifier, and any other suitable information.

The filtering module 215 indexes information associated with interactions and conversions into databases by advertiser. For example, the filtering module 215 retrieves information associated with multiple interactions and conversions associated with various advertisers from the action log 210 and indexes the retrieved information into databases associated with each advertiser. The filtering module 215 also filters interactions associated with a conversion from the action log 210 based on user identifying information associated with the conversion and user identifying information associated with the interactions. For example, the filtering module 215 retrieves information associated with interactions associated with user identifying information matching user identifying information associated with a conversion from the action log 210 and stores the retrieved information in a database for subsequent retrieval.

When retrieving information associated with interactions associated with user identifying information associated with a conversion from the action log 210, the filtering module 215 may retrieve information from the action log 210 associated with various types of information identifying the user. For example, the online system 140 associates various types of user identifying information with a user (e.g., an online system user identifier, a device identifier, an application identifier). If a type of user identifying information associated with a conversion matches user identifying information associated with the conversion, the filtering module 215 may also determine additional types of information identifying the user. Interactions associated with the additional types of user identifying information are retrieved by the filtering module 215, allowing retrieval of interactions associated with multiple types of user identifying information associated with the user.

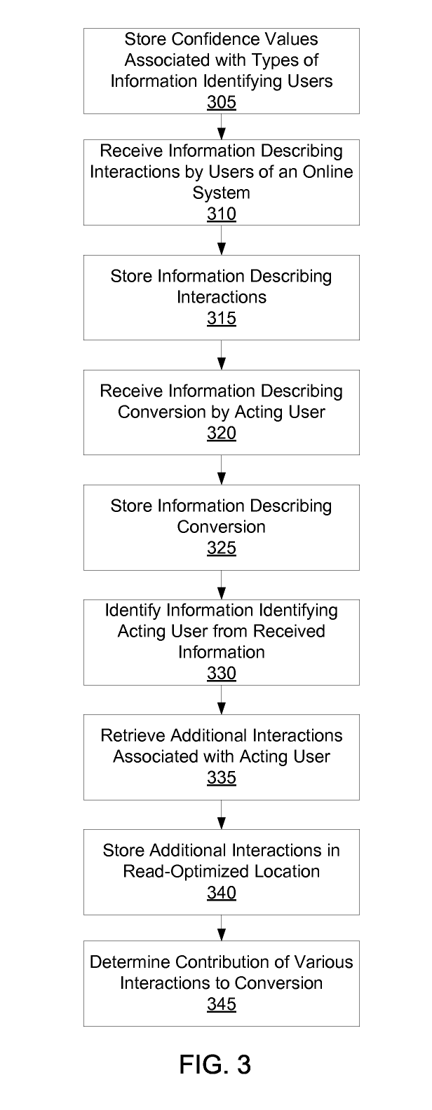

The attribution module 220 includes one or more attribution rules that are applied to an identified conversion to identify contributions of different interactions to the conversion. In one embodiment, the filtering module 215 communicates information identifying a user associated with a conversion and interactions associated with one or more types of interactions associated with at least one type of information identifying the user to the attribution module 220. The attribution module 220 includes confidence values associated with different types of user identifying information, where a confidence value associated with a type of user identifying information provides a measure of a likelihood of a type of user identifying information identifying a specific user of the online system 140. For example, an online system user identifier is associated with a larger confidence value than a client device identifier, as the online system user identifier has a greater likelihood of identifying a specific user of the online system 140. Associating confidence values with types of user interaction is further described below in conjunction with FIG. 3.

In some embodiments, the attribution module 220 associates weights with various interactions received from the filtering module 215 based on types of user identifying information associated with different interactions. For example, a weight associated with an interaction is proportional to a confidence value associated with a type of information identifying a user associated with the interaction, so interactions associated with types of information identifying a user having higher confidence values are associated with correspondingly higher weights. The attribution module 220 accounts for the weights associated with various interactions when determining contributions of various interactions to a conversion. In some embodiments, the attribution model 220 associates weights with various interactions received from the filtering module 215 based on other information associated with the user and/or the interaction. For example, the attribution module 220 includes a “time decay” model that reduces the importance of ad impressions, clicks, or other interactions based on an amount of time that has passed relative to a time when a conversation occurred.

The web server 225 links the online system 140 via the network 120 to the one or more client devices 110, as well as to the one or more third party systems 130. The web server 225 serves web pages, as well as other content, such as JAVA®, FLASH®, XML and so forth. The web server 225 may receive and route messages between the online system 140 and the client device 110, for example, instant messages, queued messages (e.g., email), text messages, short message service (SMS) messages, or messages sent using any other suitable messaging technique. A user may send a request to the web server 225 to upload information (e.g., images or videos) that are stored in the content store 210. Additionally, the web server 225 may provide application programming interface (API) functionality to send data directly to native client device operating systems, such as IOS®, ANDROID™, WEBOS® or BlackberryOS.

### Determining Contributions of Interactions to a Conversion

FIG. 3 is flow chart of one embodiment of a method for determining contributions of various interactions to a conversion associated with an advertisement. In other embodiments, the method includes different, additional, or fewer steps than those depicted by FIG. 3. Additionally, in some embodiments, the steps described in conjunction with FIG. 3 may be performed in different orders.

The online system 140 stores 305 confidence values associated with various types of information identifying online system users. A confidence value associated with a type of information identifying a user provides a measure of the likelihood of the type of information accurately identifying the user. Example types of information identifying a user include: an online system user identifier, a client device identifier, and an application identifier. In one embodiment, the online system 140 ranks types of information identifying users based on their associated confidence values. For example, a ranking of types of user identifying information has types of information identifying users more likely to accurately identify a user (i.e., types of user identifying information associated with higher confidence values) in higher positions of the ranking.

Additionally, the online system 140 receives 310 information describing one or more interactions associated with a user of the online system 140 and stores 315 the information describing the one or more interactions. For example, the online system 140 receives 310 information via a tracking pixel embedded in an advertisement indicating a user of the online 140 system was presented with the advertisement, identifies the user with an online system user identifier, a browser identifier, and a client device identifier, and indicates the time that the user was presented with the advertisement. The information describing user interactions may be received in real-time or in near real-time. In some embodiments, the online system 140 receives 310 and stores 315 information describing interactions associated with entities that are not users of the online system 140. For example, the online system 140 receives 310 information identifying an interaction with an advertisement, a timestamp associated with the interaction, and a client device identifier associated with the client device 110 used to perform the interaction. In some embodiments, the online system 140 stores 315 information describing one or more interactions with an advertisement in a write-optimized database to more efficiently store information describing the interaction.

The online system 140 receives 320 information describing a conversion associated with an advertisement and associated with an acting user. As described above, a conversion is a type of action associated with the advertisement by an advertiser as a desired type of interaction in response to presentation of the advertisement. Examples of a conversion include a purchase, an interaction with an advertisement, or other suitable interaction associated with the acting user of the online system 140 and an advertisement. The information describing the conversion may be received 320 from a tracking pixel or other tracking mechanism on a third-party system 130 or from any suitable source. Additionally, the information describing the conversion may be received in real-time or in near real-time. Information describing the conversion includes information identifying the acting user (e.g., an online system user identifier, a client device identifier, an application identifier), a description of the conversion, and a time associated with the conversion. The online system 140 stores 325 the information describing the conversion. For example, the online system 140 stores 325 stores information describing the conversion and other interactions associated with an advertiser associated with the conversion in a write-optimized database in the action log 210.

Information identifying the acting user is identified 330 from the information describing the conversion, and information describing one or more additional interactions associated with the acting user is retrieved 335 using the information identifying the acting user. Additionally, in some embodiments, if the information identifying the acting user is a particular type of information identifying the user, other types of information identifying the acting user are identified and interactions associated with the other types of information identifying the acting user are also retrieved 335. For example, if the information identifying the acting user is a device identifier, the online system 140 identifies other types of information (e.g., an online system user identifier, an application identifier) identifying the acting user and retrieves 335 interactions associated with the other types of information identifying the acting user along with interactions associated with the device identifier.

In one embodiment, information received by the online system 140 describing the conversion and one or more interactions is stored in a write-optimized database including information about a type of interaction performed, one or more types of information identifying a user performing an interaction or a conversion, and a time associated with each interaction or conversion. When the online system 140 receives 320 information describing the conversion, one or more types of user identifying information associated with the acting user are identified 330 from the received information and used to retrieve 335 one or more additional interactions associated with the acting user having at least one type of information identifying the acting user matching a type of information identifying the user included in the information describing the conversion. In some embodiments, information describing the retrieved one or more additional interactions are stored in a read-optimized database to expedite subsequent retrieval of the information by the online system 140.

In some embodiments, information identifying a user associated with an interaction and/or conversion may be inferred. If at least a threshold number or percentage of interactions associated with a type of information identifying a user are also associated with an additional type of information identifying the user, interactions associated with the type of information identifying the user are inferred to also be associated with the additional type of information identifying the user. For example, if at least a threshold percentage of interactions associated with a device identifier are also associated with an online system user identifier, interactions associated with only the device identifier are inferred to also be associated with the online system user identifier. A contribution to the conversion of an interaction having an inferred association with a type of user identifying information may be discounted.

In some embodiments, the online system 140 stores 340 the retrieved information describing the interactions in a location optimizing subsequent retrieval of the information. For example, the retrieved information is stored 340 in a separate database than the action log 210 to expedite subsequent access to the retrieved information. In some embodiments, the retrieved information is stored 340 in a read optimized database, allowing the online system 140 to more rapidly access the retrieved information.

Based on the retrieved information describing the interactions, the online system 140 communicates the interactions to an attribution model, which determines a contribution value of various interactions to the conversion. In one embodiment, the online system 140 determines 345 a contribution of various interactions to the conversion. Weights are associated with various interactions from the retrieved information. In one embodiment, a weight is associated with each interaction described by the retrieved information. A weight associated with an interaction provides a measure of the amount of contribution of the interaction to the conversion. In various embodiments, a weight associated with an interaction is based at least in part on a type of information identifying the user associated with the interaction. The weight associated with an interaction may be proportional to the confidence value associated with a type of information identifying the acting user associated with the interaction. For example, interactions associated with a type of user identifying information having a higher confidence value are associated with a higher weight. In some embodiments, the online system 140 determines the weights associated with various interactions and communicates information describing the weights and the interactions to an attribution model, which determines 345 the contribution value of various interactions to the conversion based at least in part on the weights. In some embodiments, the online system weights the various interactions based on other information associated with the user and/or the interaction (e.g., a length of elapsed time since the interaction and a time when the conversion occurred.

An attribution model or one or more attribution rules are applied to the interactions corresponding to the retrieved information to determine 345 contributions of various interactions to the conversion. The attribution rules or attribution model may be applied to the weights associated with various interactions when determining 345 contributions of various interactions to the conversion. For example, interactions are ranked based on the confidence values associated with types of information identifying the acting user associated with various interactions, and interactions having at least a threshold position in the ranking are communicated to an attribution model, which determines contributions of the interactions to the conversion. As another example, interactions associated with a type of information identifying the acting user having at least a threshold confidence value are communicated to the attribution model. In various embodiments, the contribution of an interaction to the conversion is based at least in part on a weight associated with the interaction. The online system 140 may create an attribution report for an advertiser based on application of the attribution model or attribution rules that identifies contributions of various interactions to the conversion.

### Example Identification of Interactions

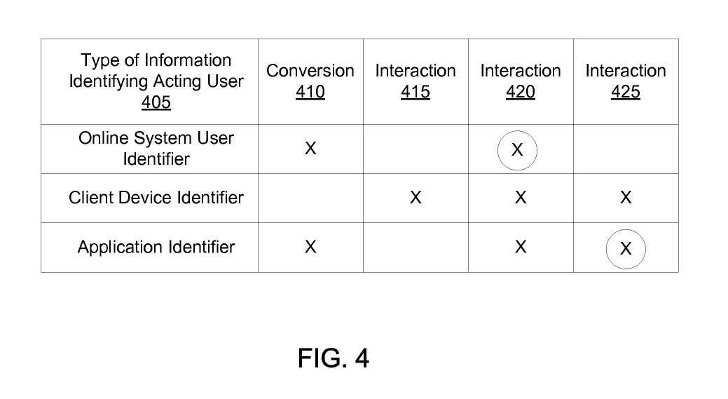

FIG. 4 shows an example of information associating interactions with types 405 of information identifying an acting user. In the example of FIG. 4, an online system user identifier, a client device identifier, and an application identifier are types 405 of information identifying the acting user. For purposes of illustration, FIG. 4 describes an example where the online system 140 receives information describing a conversion 410 associated with the acting user that includes the online system user identifier and the application identifier associated with the acting user.

Based on the online system user identifier and application identifier included in the information describing the conversion 410, the online system 140 retrieves interactions associated with various types of information identifying the acting user. In the example of FIG. 4, the online system 140 retrieves interactions 415, 420, 425, which are each associated with the acting user, but with different types 405 of information identifying the acting user. Interaction 415 is associated with is client device identifier associated with the acting user. Interaction 420 is associated with an online system user identifier, a client device identifier, and an application identifier that are each associated with the acting user. Additionally, interaction 425 is associated with the client device identifier and the application identifier associated with the acting user.

From the interactions associated with the types 405 of information associated with the acting user, the online system 140 identifies one or more interactions associated with information identifying the user that is also associated with the conversion 410. In the example of FIG. 4, interaction 420 is associated with the online system user identifier associated with the conversion and interaction 425 is associated with the application identifier associated with the conversion 410. Accordingly, the online system 140 applies an attribution model or one or more attribution rules to interaction 420 and interaction 425 to determine contributions of both interaction 420 and interaction 425 to the conversion 410. As described above in conjunction with FIG. 3, weights may be associated with interaction 420 and interaction 425 based on the confidence values associated with the types of information identifying the acting user associated with each interaction. For example, if the online system user identifier has a higher confidence value than the application identifier, a larger weight is associated with interaction 420 than with interaction 425. In various embodiments, the weights associated with interactions are used by the attribution model or attribution rules to determine a contribution of each interaction to the conversion 410.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving information describing one or more interactions of one or more users of an online system with content associated with one or more advertisers, the information describing each interaction including one or more types of information identifying a user associated with an interaction, a description of a type of the interaction, and a time associated with the interaction;
storing the received information in one or more logs, each of the one or more logs associated with an advertiser;
responsive to receiving information describing a conversion associated with the advertiser and identifying an acting user:
identifying one or more types of information identifying the acting user;
identifying one or more interactions to which the conversion is capable of being attributed associated based at least in part on matching one or more types of information identifying the acting user associated with the one or more interactions to information associated with the acting user included in the information describing the conversion;
storing the information describing the identified one or more interactions of the user in a log; and
determining a contribution of each of the identified one or more interactions of the user to the conversion by applying one or more rules to the identified one or more interactions.

2. The method of claim 1, wherein a log associated with the advertiser comprises a write-optimized database.

3. The method of claim 1, wherein the log comprises a read-optimized database.

4. The method of claim 1, wherein the description of the type of interaction is selected from a group consisting of: viewing one or more advertisements, interacting with one or more advertisements, accessing one or more objects associated with one or more advertisements, making one or more purchases associated with an advertiser associated with the advertisement, requesting one or more services associated with the advertiser associated with the advertisement, attending one or more events associated with the advertiser associated with the advertisement, and any combination thereof.

5. The method of claim 1, wherein the one or more interactions of one or more users of the online system comprise one or more prior conversions.

6. The method of claim 1, wherein the received information stored in the one or more logs is associated with a specified time period.

7. The method of claim 1, wherein the information describing one or more interactions of one or more users of the online system with content associated with one or more advertisers is received in real-time.

8. The method of claim 1, wherein the information describing the conversion associated with the advertiser and the acting user is received in real-time via a tracking mechanism.

9. A method comprising:
receiving information describing one or more interactions of one or more users of an online system with content associated with one or more advertisers, the information describing each interaction including one or more types of information identifying a user associated with an interaction, a description of a type of the interaction, and a time associated with the interaction;
storing the received information in one or more logs, each of the one or more logs associated with an advertiser;
responsive to receiving information describing a conversion associated with the advertiser and identifying an acting user, identifying one or more types of information identifying the acting user;
retrieving information describing one or more interactions to which the conversion is capable of being attributed that are associated with at least one type of information identifying the acting user;
storing the retrieved information describing one or more interactions to which the conversion is capable of being attributed in a log; and
determining a contribution to the conversion of each of the one or more interactions to which the conversion is capable of being attributed by applying one or more rules to the information stored in the log.

10. The method of claim 9, wherein a log associated with the advertiser comprises a write-optimized database.

11. The method of claim 9, wherein the log comprises a read-optimized database.

12. The method of claim 9, wherein the description of the type of interaction is selected from a group consisting of: viewing one or more advertisements, interacting with one or more advertisements, accessing one or more objects associated with one or more advertisements, making one or more purchases associated with an advertiser associated with the advertisement, requesting one or more services associated with the advertiser associated with the advertisement, attending one or more events associated with the advertiser associated with the advertisement, and any combination thereof.

13. The method of claim 9, wherein the one or more interactions of one or more users of the online system comprise one or more prior conversions.

14. The method of claim 9, wherein the received information stored in the one or more logs is associated with a specified time period.

15. The method of claim 9, wherein the information describing one or more interactions of one or more users of the online system with content associated with one or more advertisers is received in real-time.

16. The method of claim 9, wherein the information describing the conversion associated with the advertiser and the acting user are received in real-time via a tracking mechanism.

17. A computer program product comprising a computer readable storage medium having instructions encoded therein that, when executed by a processor, cause the processor to:
receive information describing one or more interactions of one or more users of an online system with content associated with one or more advertisers, the information describing each interaction including one or more types of information identifying a user associated with an interaction, a description of a type of the interaction, and a time associated with the interaction;
store the received information in one or more logs, each of the one or more logs associated with an advertiser;
responsive to receiving information describing a conversion associated with the advertiser and identifying an acting user, identify one or more types of information identifying the acting user;
retrieve information describing one or more interactions to which the conversion is capable of being attributed that are associated with at least one type of information identifying the acting user;
store the retrieved information describing one or more interactions to which the conversion is capable of being attributed in a log; and
determine a contribution to the conversion of each of the one or more interactions to which the conversion is capable of being attributed by applying one or more rules to the information stored in the log.

18. The computer program product of claim 17, wherein a log associated with the advertiser comprises a write-optimized database.

19. The computer program product of claim 17, wherein the log comprises a read-optimized database.

20. The computer program product of claim 17, wherein the description of the type of interaction is selected from a group consisting of: viewing one or more advertisements, interacting with one or more advertisements, accessing one or more objects associated with one or more advertisements, making one or more purchases associated with an advertiser associated with the advertisement, requesting one or more services associated with the advertiser associated with the advertisement, attending one or more events associated with the advertiser associated with the advertisement, and any combination thereof.
